(19) United States
(12) Patent Application Publication
(10) Pub. No.: US 2012/0033256 A1
(43) Pub. Date: Feb. 9, 2012

(54) INFORMATION PROCESSING APPARATUS, JOB PROCESSING SYSTEM, JOB TRANSMISSION PATH CONTROL METHOD, AND STORAGE MEDIUM STORING CONTROL PROGRAM THEREFOR

(75) Inventor: Kensuke KAWAJIRI, Kawasaki-shi (JP)

(73) Assignee: CANON KABUSHIKI KAISHA, Tokyo (JP)

(21) Appl. No.: 13/196,366

(22) Filed: Aug. 2, 2011

(30) Foreign Application Priority Data
Aug. 6, 2010 (JP) 2010-177506

(51) Int. Cl. G06F 3/12

(52) U.S. Cl. 358/1.15

(57) ABSTRACT

An information processing apparatus that is capable of determining a transmission path of a job when a job processing apparatus executes the job that is transmitted from a server. The information processing apparatus is connected to the server by a first connection configuration. A determination unit determines whether a connection configuration between the information processing apparatus and the job processing apparatus is a second connection configuration that is different from the first connection configuration. A check unit checks whether the job processing apparatus is connected to the server by the first connection configuration when the connection configuration between the information processing apparatus and the job processing apparatus is the second connection configuration. An instruction unit instructs the server on either of first transmission that transmits the job to the job processing apparatus and second transmission that transmits the job to the information processing apparatus according to the check result.

### BACKGROUND OF THE INVENTION

1. Field of the Invention

The present invention relates to an information processing apparatus, a job processing system, a job transmission path control method, and a storage medium storing a control program therefor. Particularly, the present invention relates to a technique that determines a transmission path of a job from a server to a device like a terminal device when the device executes a job process (for example, a printing process) according to the job.

2. Description of the Related Art

In general, there is a known apparatus (a job processing apparatus) that has no operation panel to reduce a cost and is operated by using an application executed by a personal computer (PC). This type of apparatus can be connected to the PC via a network or a USB. Then, there is a known technique to change a connection setting according to a connection configuration between the PC and the apparatus (for example, see Japanese Laid-Open Patent Publication (Kokai) No. 2009-86905 (JP 2009-86905A)).

JP 2009-86905A discloses a selection of operation modes at the time when installing a device driver for controlling an image forming apparatus, which is provided with a normal mode and a secure mode as print operation modes, to a PC. Here, when the connection configuration between the PC and the image forming apparatus is a network connection, a user is allowed to select a default operation mode. When the connection configuration is a local connection, the normal mode is automatically set as the default operation mode.

On the other hand, there is a known technique that a user requires to transmit a job stored in a server via an operation panel of an apparatus (it is also called a device) and the device prints according to the job transmitted from the server.

Incidentally, when the device processes a job (for example, printing) that is transmitted from the server, it is necessary to determine whether the device is connected to the network and to determine a transmission path of the job. That is, unless the transmission path of the job is determined, the job stored in the server cannot be transmitted to the device.

Since the technique disclosed in JP 2009-86905A changes the setting (the operation mode) of the PC application according to the connection configuration between the PC and the device but does not determine the transmission path of the job, the device cannot print according to the job stored in the server when the device is not connected to the network.

### SUMMARY OF THE INVENTION

The present invention provides an information processing apparatus, a job processing system, a job transmission path control method, and a storage medium storing a control program therefor, which are capable of determining a transmission path of a job when a job processing apparatus executes the job that is transmitted from a server.

Accordingly, a first aspect of the present invention provides an information processing apparatus that can be connected to a job processing apparatus, that can be connected to a server that stores a job by a first connection configuration, and that instructs the job processing apparatus to execute the job, comprising a determination unit configured to determine whether a connection configuration between the information processing apparatus and the job processing apparatus is a second connection configuration that is different from the first connection configuration, a check unit configured to check whether the job processing apparatus is connected to the server by the first connection configuration when the determination unit determines that the connection configuration between the information processing apparatus and the job processing apparatus is the second connection configuration, and an instruction unit configured to instruct the server on either of first transmission that transmits the job to the job processing apparatus and second transmission that transmits the job to the information processing apparatus according to the check result by the check unit.

Accordingly, a second aspect of the present invention provides a job processing system comprising the information processing apparatus according to the first aspect, a job processing apparatus configured to be connected to the information processing apparatus, and a server configured to be connected to the information processing apparatus by a first connection configuration, wherein the job processing apparatus executes the job according to an instruction from the information processing apparatus.

Accordingly, a third aspect of the present invention provides a job transmission path control method, which is used in a job processing system having a job processing apparatus, a server that stores a job, and an information processing apparatus that is connected to the job processing apparatus and is connected to the server by a first connection configuration, for controlling a transmission path through which a job is transmitted from the server to the job processing apparatus, the method comprising a determination step of determining whether a connection configuration between the information processing apparatus and the job processing apparatus is a second connection configuration that is different from the first connection configuration, a check step of checking whether the job processing apparatus is connected to the server by the first connection configuration when it is determined that the connection configuration between the information processing apparatus and the job processing apparatus is the second connection configuration in the determination step, and an instruction step of instructing the server in either of first transmission that transmits the job to the job processing apparatus and second transmission that transmits the job to the information processing apparatus according to the check result in the check step.

Accordingly, a fourth aspect of the present invention provides a non-transitory computer-readable storage medium storing a control program causing a computer to execute a job transmission path control method, which is used in a job processing system having a job processing apparatus, a server that stores a job, and the computer that is connected to the job processing apparatus and is connected to the server by a first connection configuration, for controlling a transmission path through which a job is transmitted from the server to the job processing apparatus, the job transmission path control method comprising a determination step of determining whether a connection configuration between the computer and the job processing apparatus is a second connection configuration that is different from the first connection configuration, a check step of checking whether the job processing apparatus is connected to the server by the first connection configuration when it is determined that the connection configuration between the computer and the job processing apparatus is the second connection configuration in the determination step, and an instruction step of instructing the server in either of first transmission that transmits the job to the job processing apparatus and second transmission that transmits the job to the computer according to the check result in the check step.

According to the present invention, since the transmission path of the job is determined according to the connection configuration when the job processing apparatus executes the job that is transmitted from the server, the user can process the job stored in the server by a desired job processing apparatus without concern for the connection configuration.

Further features of the present invention will become apparent from the following description of exemplary embodiments with reference to the attached drawings.

### BRIEF DESCRIPTION OF THE DRAWINGS

FIG. 1 is a view showing an example of a printing system that is one of job processing systems according to a first embodiment of the present invention.

FIG. 2 is a block diagram schematically showing a hardware configuration of the PC shown in FIG. 1.

FIG. 3 is a block diagram showing a hardware configuration of a controller unit of each of the devices shown in FIG. 1.

FIG. 4 is a view showing an example of a UI application screen displayed on a display unit of the PC shown in FIG. 1 for operating a device.

FIG. 5 is a view showing an example of a server printing dialogue box displayed on the display unit according to an operation of the server print button of the UI application screen shown in FIG. 4.

FIG. 6 is a flowchart showing a job transmission path determination process that is executed by the PC shown in FIG. 1.

FIG. 7 is a view showing an example of a setting dialogue box displayed on the display unit according to an operation of the setting button of the UI application screen shown in FIG. 4.

FIG. 8 is a flowchart showing a job transmission path determination process according to a second embodiment of the present invention.

### DESCRIPTION OF THE EMBODIMENTS

Hereafter, embodiments according to the present invention will be described in detail with reference to the drawings.

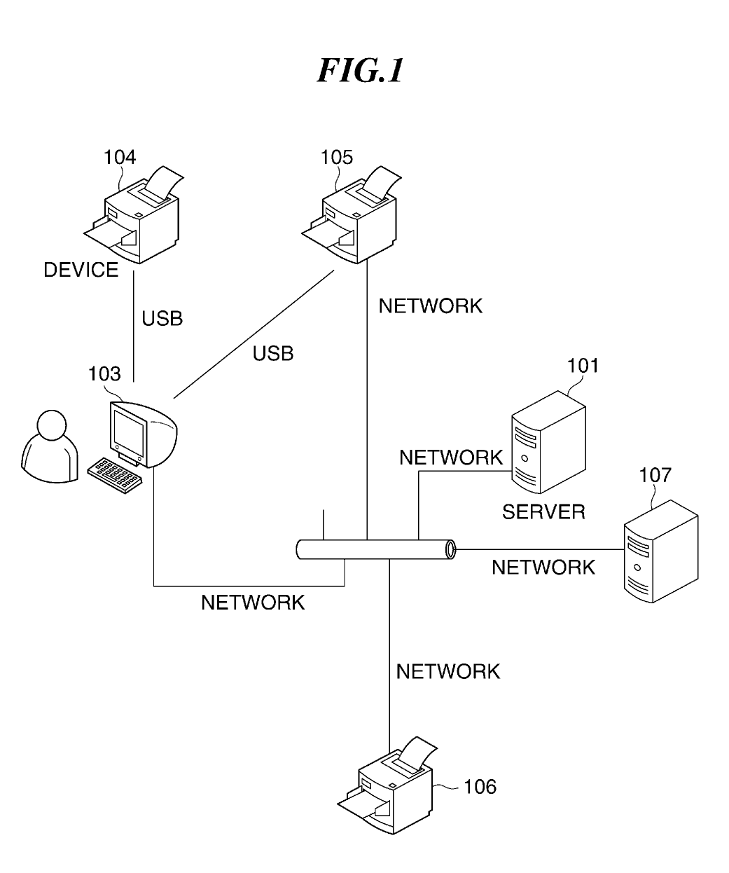

FIG. 1 is a view showing an example of a printing system that is one of job processing systems according to a first embodiment of the present invention.

As shown in FIG. 1, the illustrated printing system has a plurality of image forming apparatuses (job processing apparatuses, they will be also called devices) 104 through 106. Then, the devices 104 and 105 are connected to a PC (an information processing apparatus) 103 through a USB connection (a second connection configuration). The devices 105 and 106, the PC 103, and servers 101 and 107 are mutually connected via a network (a first connection configuration).

As mentioned above, since the PC 103 is connected to the devices 104 through 106 via the USB connection or the network, a user can change various settings of the devices 104 through 106 and can provide instructions to the devices 104 through 106 by operating a UI (user interface) application that runs on the PC 103.

In the illustrated example, the server 101 and the server 107 store a plurality of jobs (they are called print jobs hereafter), and each of these servers 101 and 107 has a function to transmit a job via the network. The user can provide a job transmission instruction to the servers 101 and 107 by operating the UI application running on the PC 103, and thereby can control the servers 103 and 107 to transmit the job to the device designated by the transmission instruction.

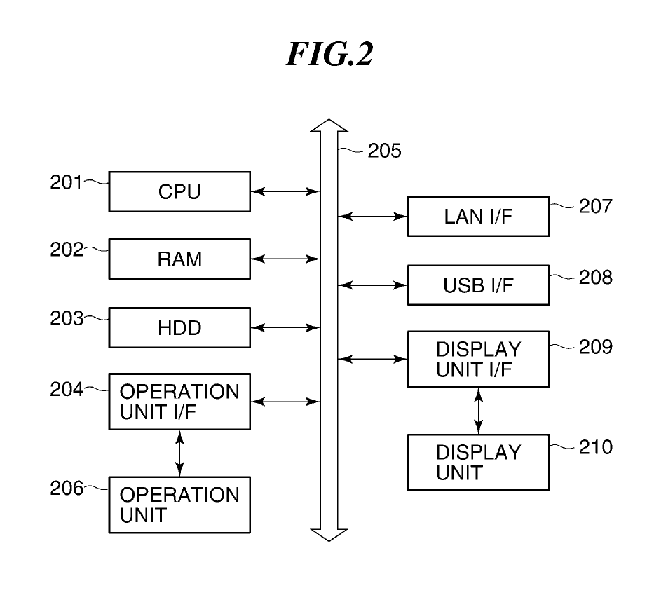

FIG. 2 is a block diagram schematically showing a hardware configuration of the PC 103 shown in FIG. 1.

A CPU 201 manages the entire control of the PC. A RAM 202 is a system work memory for an operation of the CPU 201, and is also used as a program memory to record programs. An HDD (a hard disk drive) 203 stores data. An operation unit I/F (interface) 204 is an interface with an operation unit 206, and receives input information from the operation unit 206. Then, the operation unit I/F 204 transfers input information inputted by a user via the operation unit 206 to the CPU 201.

A display unit I/F 209 is an interface with a display unit 210, and outputs an output signal to a display unit 210 according to control by the CPU 201. A USB interface 208 is a functional unit for connecting with a USB device, and is used to acquire status of the USB device via the USB and to return the status. A LAN interface 207 is a functional unit for connecting with a LAN, and is used to acquire status of the USB device via the LAN and to return the status.

Then, the CPU 201, the RAM 202, the HDD 203, the operation unit I/F 204, the LAN I/F 207, the USB IF 208, and the display unit I/F 209 are mutually connected via a system bus 205.

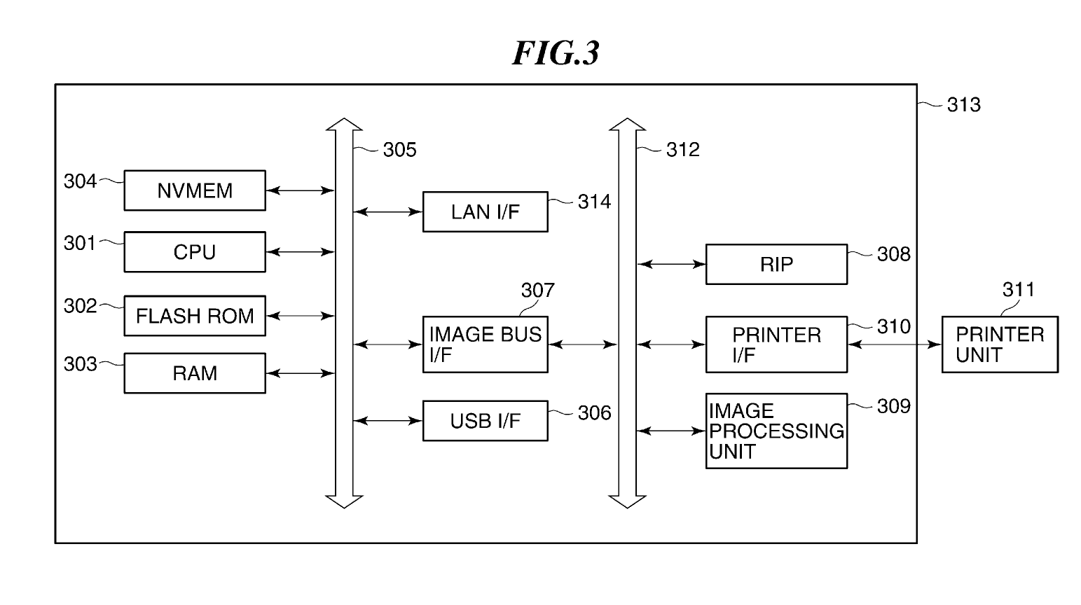

FIG. 3 is a block diagram showing a hardware configuration of a controller unit of each of the devices 104 through 106 shown in FIG. 1.

As shown in FIG. 3, the controller unit 313 with which each of the devices 104 through 106 is provided is connected with a printer unit 311 that functions as an image forming device. Then, the controller unit 313 outputs image data to the printer unit 311, and receives device information that shows status of the printer unit 311 from the printer unit 311.

The controller unit 313 has a CPU 301 that controls the printer unit 311 while controlling each part of the controller unit 313. A RAM 303 is a system work memory for an operation of the CPU 301, and is also used as a program memory that records programs and an image memory that stores image data temporally. A nonvolatile memory (NVMEM) 304 stores various kinds of setting information etc. A flash ROM 302 stores various control programs that are executed by the CPU 301 for control.

A USB interface 306 is used for a USB connection to the PC 103 (FIG. 1), and a LAN interface 314 is used for network connection to the PC 103 or to the servers 101 and 107. The CPU 301, the flash ROM 302, the RAM 303, the NVMEM 304, the USB interface 306, and the LAN interface 314 are mutually connected via a system bus 305.

An image bus I/F 307 is a bus bridge that connects the system bus 305 with an image bus 312 that transmits image data at high speed, and that converts a data structure. It should be noted that the image bus 312 comprises a PCI bus or IEEE1394. A raster image processor (RIP) 308, a printer I/F 310, and an image processing unit 309 are connected to the image bus 312, and the printer unit 311 is connected to the printer I/F 310.

The RIP 308 develops vector data like a PDL code to a bitmap image. The printer I/F 310 converts the image data between a synchronous system and an asynchronous system. The image processing unit 309 performs correction, processing, editing, etc. to inputted image data, and performs correction, resolution conversion, etc. to the printer unit 311 with respect to print output image data.

The image processing unit 309 processes image data to rotate an image, and converts multi valued image data into JPEG. The image processing unit 309 performs compression extension processes such as JBIG, MMR, and MH about binary image data.

The printer unit 311 converts raster image data into an image, and prints it on a sheet. The printer unit 311 prints by an electrophotography process that uses a photoconductive drum or a photoconductive belt, for example. It should be noted that the printer unit 311 may employ an inkjet method that discharges ink from a fine nozzle array to print an image directly on a sheet, for example. Anyway, the printer unit 311 prints based on image data like raster image data. An instruction from the CPU 301 starts a print operation by the printer unit 311.

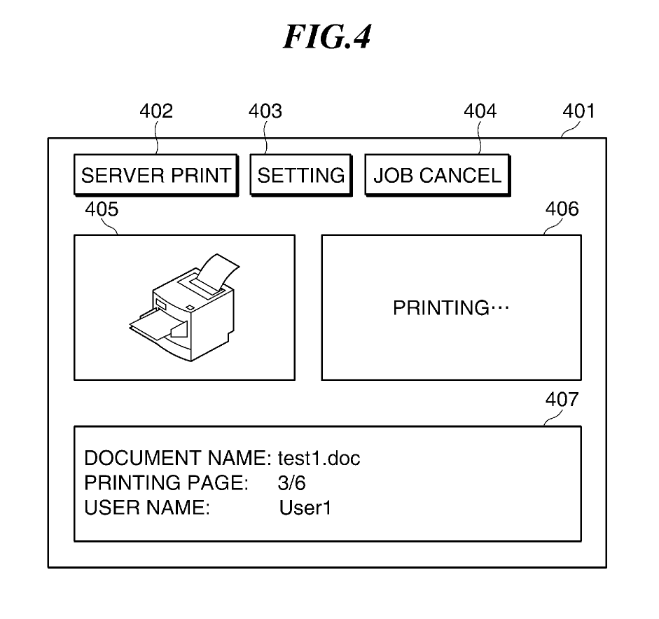

FIG. 4 is a view showing an example of a UI application screen displayed on the display unit 210 of the PC 103 shown in FIG. 1 for operating the devices 104 through 106. It should be noted that each of the devices 104 through 106 shown in FIG. 1 is not provided with an operation panel.

In the PC 103, when operating one of the devices 104 through 106, the CPU 201 executes a UI application and displays a UI application screen 401 on the display unit 210. It should be noted that the UI application screen 401 is given for each of the devices 104 through 106.

The UI application that operates on the CPU 201 is connected with the devices 104 through 106 via the USB interface 208 or the LAN interface 207. A user selects which device will be connected to the UI application when installing the UI application. That is, when the UI application is installed into the PC 103, the UI application is associated with one of the devices 104 through 106.

A device status display part 405 is displayed on the UI application screen 401. The device status display part 405 displays an icon corresponding to the status of the device connected with the UI application. FIG. 4 shows a state where the device is printing.

A device status explanation part 406 is displayed on the UI application screen 401. Text information according to the status of the device connected with the UI application is displayed in the device status explanation part 406. In the example shown in FIG. 4, since the device is printing, the text information of “PRINTING” is displayed.

A job execution situation display part 407 is displayed on the UI application screen 401. Printing state of the job that is executed by the device connected with the UI application is shown in the job execution situation display part 407. The example shown in FIG. 4 shows that the user of which the name is “User1” is printing the job of which the document name is “test1.doc”, and that 3 pages among 6 pages have been printed. It should be noted that the job execution situation display part 407 displays no information when the device is not printing.

A server print button 402 is displayed on the UI application screen 401. When a user selects the server print button 402 using the operation unit 206 (FIG. 2), a server printing dialogue box 501 mentioned later will be displayed on the display unit 210 (FIG. 2).

A setting button 403 is displayed on the UI application screen 401. When a user operates the setting button 403 using the operation unit 206, a device setting dialogue box 701 mentioned later will be displayed on the display unit 210.

A job cancel button 404 is displayed on the UI application screen 401. When a user operates the job cancel button 404 using the operation unit 206, the job that the device concerned is executing can be stopped.

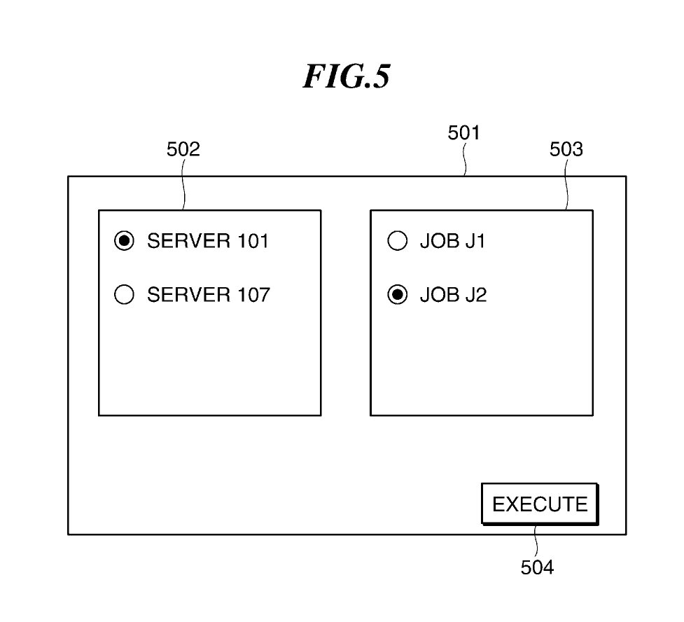

FIG. 5 is a view showing an example of the server printing dialogue box 501 displayed on the display unit 210 according to an operation of the server print button of the UI application screen shown in FIG. 4.

The server printing dialogue box 501 is used when a user prints the job stored in the servers 101 and 107 by the device connected with the UI application.

As shown in FIG. 5, a server selection part 502 and a job selection part 503 are included in the server printing dialogue box 501 displayed on the display unit 210 (FIG. 2). Server names of the servers that are connected to the UI application via the LAN interface 207 is displayed on the server selection part 502. The user can select one of the server names displayed in the server selection part 502. In the example shown in FIG. 5, the server 101 is selected in the server selection part 502 (the server 101 is a selected server).

The job names that the server selected in the server selection part 502 holds are displayed in the job selection part 503. The user can select one of the job names displayed in the job selection part 503. In the example shown in FIG. 5, the job J2 is selected in the job selection part 503 (the job J2 is a selected job).

An execution button 504 is displayed in the server printing dialogue box 501. When the user selects the execution button 504 using the operation unit 206, the UI application, i.e., the CPU 201, requires the server 101 via the LAN interface 207 to designate a transmitting destination and to transmit the selected job J2 to the transmitting destination. It should be noted that the determination of the transmitting destination will be described later.

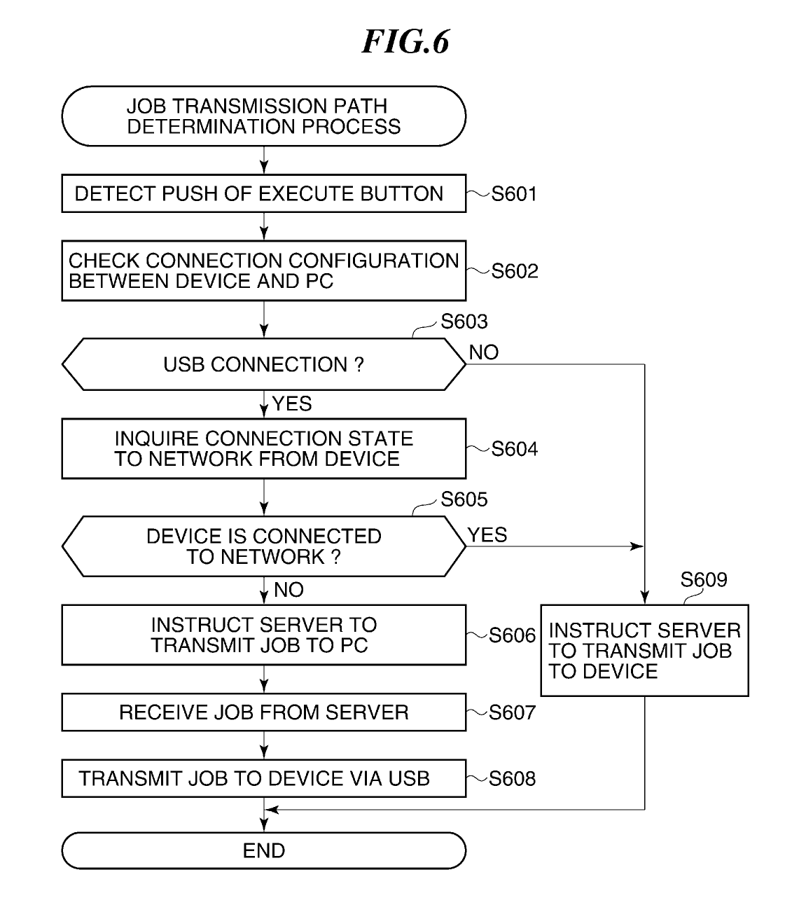

FIG. 6 is a flowchart showing a job transmission path determination process that is executed by the PC 103 shown in FIG. 1. It should be noted that the job transmission path concerned is determined by the UI application that operates on the CPU 201.

When the execution button 504 is selected in the server printing dialogue box 501 shown in FIG. 5, the CPU 201 requires the server 101 selected in the server printing dialogue box 501 via LAN interface 207 to transmit the job J2 to the designated transmitting destination. Here, the transmitting destination is one of the devices 104 through 106.

When detecting a push of the execution button 504 (step S601), the CPU 201 checks the connection configuration between the PC 103 and the device that is the transmitting destination (step S602). The CPU 201 determines whether the connection configuration between the PC 103 and the device that is the transmitting destination is the USB connection using the USB interface 208 (step S603).

When the connection configuration is the USB connection (YES in the step S603), the CPU 201 inquires the connection state to the network from the device that is the transmitting destination (step S604). When receiving a network connection state response showing the network connection state from the device that is the transmitting destination in response to the query, the CPU 201 determines whether the device that is the transmitting destination is connected to the network, and then, the CPU 201 obtains a determination result (step S605).

When the determination result shows that the device that is the transmitting destination is not connected to the network (NO in the step S605), the CPU 201 instructs the server 101 to transmit the job J2 to the PC 103 (a second transmission: step S606). Then, the CPU 201 receives the job J2 from the server 101 (step S607), and transmits the job J2 to the device that is the transmitting destination via the USB interface 208 (step S608). And the CPU 201 finishes the job transmission path determination process.

When the connection configuration is not the USB connection (NO in the step S603), i.e., when the connection configuration is the network connection, the CPU 201 instructs the server 101 to transmit the job J2 to the device that is the transmitting destination (first transmission: step S609). And the CPU 201 finishes the job transmission path determination process.

When the determination result shows that the device that is the transmitting destination is connected to the network (YES in the step S605), the CPU 201 proceeds with the process to step S609, and requires the server 101 to transmit the job J2 to the device that is the transmitting destination.

Here, the device 106 is assumed as the transmitting destination. The PC 103 is connected with the device 106 via the LAN interface 207 only. Therefore, the CPU 201 determines that the connection configuration is the network connection in the step S603. Then, the CPU 201 instructs the server 101 to transmit the job J2 to the device 106 in the step S609.

Next, the device 105 is assumed as the transmitting destination. The device 105 is connected to the PC 103 via the USB connection and is connected to the network. Therefore, the CPU 201 determines that the device 105 is connected by the USB connection in the step S603. On the other hand, since the device 105 is also connected to the network, the CPU 201 determines that the device 105 is connected to the network in the step S605, and instructs the server 101 to transmit the job J2 to the device 105 in the step S609.

When the transmitting destination is the device 105, the CPU 201 may instruct the server 101 to transmit the job J2 to the PC 103 rather than instructs the server 101 to transmit the job J2 to the device 105. In this case, the CPU 201 transmits the job J2 concerned to the device 105 via the USB interface 208.

Further, the device 104 is assumed as the transmitting destination. The device 104 is connected to the PC 103 via the USB connection only. Therefore, the CPU 201 determines that the device 104 is connected by the USB connection in the step S603. Then, the CPU 201 determines that the device 104 is not connected to the network in the step S605, and instructs the server 101 to transmit the job J2 to the PC 103 in the step S606. Accordingly, the CPU 201 transmits the job J2 to the device 104 via the USB interface 208.

As mentioned above, in the first embodiment, since the PC 103 determines the connection configurations of the job processing devices 104 through 106 (the image forming apparatuses etc.) to determine the transmission path through which the job is transmitted from the server 101 or 107 to the job processing device, a user can print the job stored in the server by the desired device without concern for the connection configuration of the job processing device.

Next, a printing system that has an image forming apparatus according to a second embodiment of the present invention will be described.

In the second embodiment, the hardware configuration is similar to the printing system described in the first embodiment.

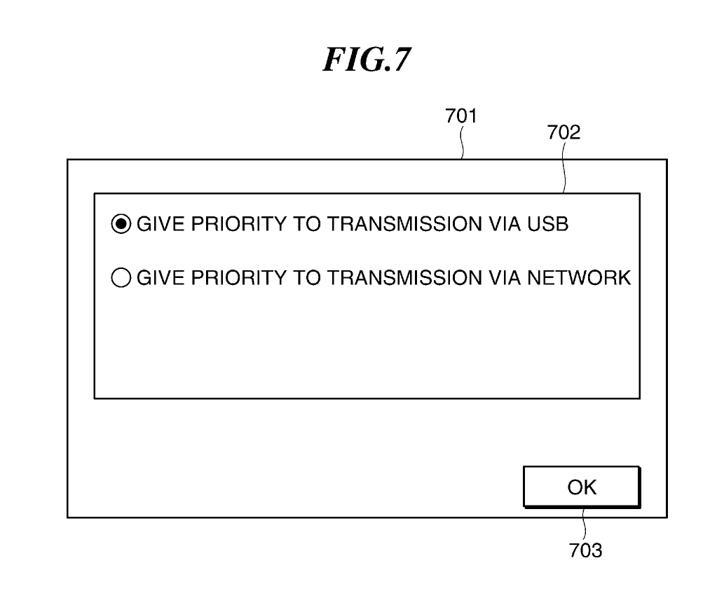

FIG. 7 is a view showing an example of a setting dialogue box 701 displayed on the display unit 210 according to an operation of the setting button 403 of the UI application screen 401 shown in FIG. 4.

The setting dialog screen 701 is displayed on the display unit 210 when a user writes a transmission path priority value (a priority connection configuration) about a job in the NVMEM 304 in each of the devices 104 through 106. The transmission path priority value about a job is used for determining a path through which a job is received from the server 101 or 107. For example, when the device 105 receives a job from the server 101, the transmission path priority value is used to determine which of the path via the LAN interface 314 and the path via the PC 103 and the USB interface 306 has priority to receive a job.

A priority selection part 702 is displayed in the setting dialog screen 701. The user can give priority to one of the transmission by the USB connection and the transmission by the network connection by the priority selection part 702. The example shown in FIG. 7 shows that the priority is given to the transmission by the USB connection.

An OK button 703 is displayed in the setting dialogue box 701. When the user operates the OK button 703 using the operation unit 206, the CPU 201 sets the selection in the priority selection part 702 as the transmission path priority value. Then, the CPU 201 transmits writing instructions to the devices 104 through 106 via the USB interface 208 or the LAN interface 207. The CPU 301 writes the transmission path priority value into the NVMEM 304 in each of the devices 104 through 106.

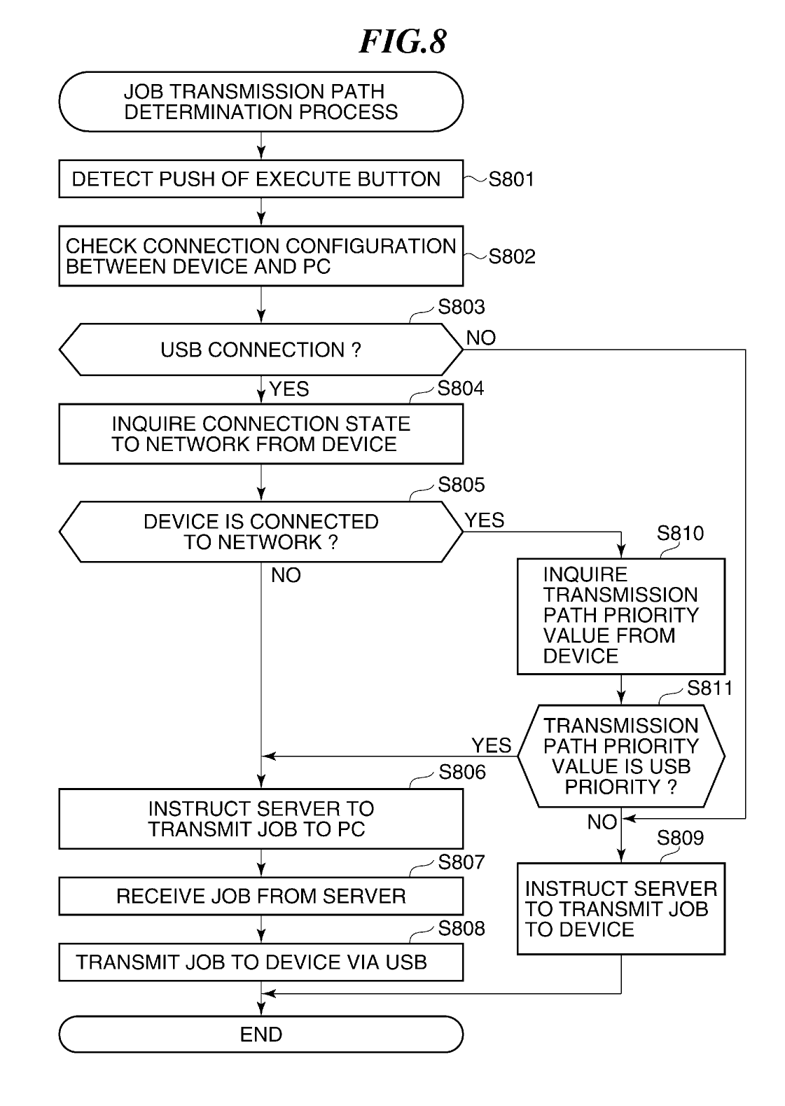

FIG. 8 is a flowchart showing a job transmission path determination process according to the second embodiment of the present invention.

It is assumed that the execution button 504 in the server printing dialogue box 501 shown in FIG. 5 is selected. When detecting a push of the execution button 504 (step S801), the CPU 201 checks the connection configuration between the PC 103 and the device that is the transmitting destination (step S802). The CPU 201 determines whether the connection configuration between the PC 103 and the device that is the transmitting destination is the USB connection using the USB interface 208 (step S803).

When the connection configuration is the USB connection (YES in the step S803), the CPU 201 inquires the connection state to the network from the device that is the transmitting destination (step S804). When receiving a network connection state response showing the network connection state from the device that is the transmitting destination in response to the query, the CPU 201 determines whether the device that is the transmitting destination is connected to the network (step S805).

When the device that is the transmitting destination is not connected to the network (NO in the step S805), the CPU 201 requires the server 101 to transmit the job J2 to the PC 103 (step S806). Then, the CPU 201 receives the job J2 from the server 101 (step S807), and transmits the job J2 to the device that is the transmitting destination via the USB interface 208 (step S808). And the CPU 201 finishes the job transmission path determination process.

When the connection configuration is not the USB connection (NO in the step S803), i.e., when the connection configuration is the network connection, the CPU 201 requires the server 101 to transmit the job J2 to the device that is the transmitting destination (step S809). And the CPU 201 finishes the job transmission path determination process.

When the device that is the destination is connected to the network (YES in the step S805), the CPU 201 inquires the transmission path priority value from the device that is the transmitting destination (step S810). In response to the query, the CPU 301 of the device that is the transmitting destination transmits the transmission path priority value to the PC 103 via the network.

The CPU 201 determines whether the transmission path priority value is set as USB priority (step S811). When the transmission path priority value is set as the USB priority (YES in the step S811), the CPU 201 proceeds with the process to the step S806, and requires the server 101 to transmit the job J2 to the PC 103.

On the other hand, when the transmission path priority value is not set as the USB priority (NO in the step S811), i.e., when the transmission path priority value is set as network priority, the CPU 201 proceeds with the process to the step S809, and requires the server 101 to transmit the job J2 to the device that is the transmitting destination.

Here, in FIG. 1, the device 104 is connected by the USB connection only, and the device 106 is connected by the network connection only. Therefore, when the transmitting destination is the device 104, the PC 103 instructs the server 101 to transmit the job J2 to the PC 103 regardless of setting of the transmission path priority value. When the transmitting destination is the device 106, the PC 103 instructs the server 101 to transmit the job J2 to the device 106.

On the other hand, since the device 105 is connected by both of the USB connection and the network connection, when the transmitting destination is the device 105, it is determined whether the job is transmitted via the USB or the network according to the transmission path priority value as mentioned above. Then, when determining to transmit via the USB, the CPU 201 instructs the server 101 to transmit the job J2 to the PC 103. When determining to transmit via the network, the CPU 201 instructs the server 101 to transmit the job J2 to the device 105.

Thus, according to the second embodiment, the user can set the desired job transmission path with priority for the job processing device 105 that is connected via the USB connection and the network connection. As a result, the user can print the job stored in the server by the desired device, when the user sets one of the USB and the network according to the connection configuration of the job processing device.

As is clear from the above description, the PC 103 is an information processing apparatus, the CPU 201 functions as a determination unit, a check unit, and an instruction unit. The CPU 201 and the dialogue box 501 shown in FIG. 5 function as a server selection unit and a job selection unit. The CPU 201 and the dialogue box 701 shown in FIG. 7 function as a priority setting unit.

Although the embodiments of the invention have been described, the present invention is not limited to the above-mentioned embodiments, the present invention includes various modifications as long as the concept of the invention is not deviated. For example, although the USB is described as an example of the connection configurations other than the network between the PC and the device in the description in the above-mentioned embodiments, an interface other than the USB may be used for connection. When the connection configuration between the server and the PC is the first connection configuration, the device and the PC can be connected by the first connection configuration or the second connection configuration. In the description of the above-mentioned embodiments, the first connection configuration is a network and the second connection configuration is a USB. However, since the first and second connection configurations are not limited to the network and the USB, other interfaces may be used.

For example, a job transmission path control method that corresponds to the function of the above-mentioned embodiment may be performed by the information processing apparatus. A control program that has the function of the above-mentioned embodiment may be executed by the information processing apparatus (i.e., a computer).

In this case, each of the control method and the control program has a determination step, a check step, and an instruction step at least. It should be noted that the program is stored into a computer-readable storage medium, for example.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-177506, filed on Aug. 6, 2010, which is hereby incorporated by reference herein in its entirety.

What is claimed is:

1. An information processing apparatus that can be connected to a job processing apparatus, that can be connected to a server that stores a job by a first connection configuration, and that instructs the job processing apparatus to execute the job, comprising:
a determination unit configured to determine whether a connection configuration between the information processing apparatus and the job processing apparatus is a second connection configuration that is different from the first connection configuration;
a check unit configured to check whether the job processing apparatus is connected to the server by the first connection configuration when said determination unit determines that the connection configuration between the information processing apparatus and the job processing apparatus is the second connection configuration; and
an instruction unit configured to instruct the server on either of first transmission that transmits the job to the job processing apparatus and second transmission that transmits the job to the information processing apparatus according to the check result by said check unit.

2. The information processing apparatus according to claim 1, further comprising a transferring unit configured to transfer the job to the job processing apparatus when the job concerned is received from the server.

3. The information processing apparatus according to claim 1, wherein said instruction unit instructs the server on the first transmission when said determination unit determines that the connection configuration between the information processing apparatus and the job processing apparatus is the first connection configuration.

4. The information processing apparatus according to claim 1, wherein job processing apparatuses and servers are connected to the information processing apparatus, further comprising:
a server selection unit configured to select one of the servers as a selected server; and
a job selection unit configured to select one of jobs that are stored in the selected server as a selected job,
wherein said instruction unit instructs the selected server to transmit the selected job.

5. The information processing apparatus according to claim 1, wherein the first connection configuration is a network connection and the second connection configuration is a USB connection.

6. The information processing apparatus according to claim 1, further comprising a priority setting unit configured to set either of the first and second connection configurations as a priority connection configuration,
wherein said instruction unit instructs the server on either of the first and second transmissions according to the priority connection configuration when the priority connection configuration is set by said priority setting unit.

7. A job processing system comprising:
the information processing apparatus according to claim 1;
a job processing apparatus configured to be connected to said information processing apparatus; and
a server configured to be connected to said information processing apparatus by a first connection configuration,
wherein said job processing apparatus executes the job according to an instruction from said information processing apparatus.

8. A job transmission path control method, which is used in a job processing system having a job processing apparatus, a server that stores a job, and an information processing apparatus that is connected to the job processing apparatus and is connected to the server by a first connection configuration, for controlling a transmission path through which a job is transmitted from the server to the job processing apparatus, the method comprising:
a determination step of determining whether a connection configuration between the information processing apparatus and the job processing apparatus is a second connection configuration that is different from the first connection configuration;
a check step of checking whether the job processing apparatus is connected to the server by the first connection configuration when it is determined that the connection configuration between the information processing apparatus and the job processing apparatus is the second connection configuration in said determination step; and
an instruction step of instructing the server on either of first transmission that transmits the job to the job processing apparatus and second transmission that transmits the job to the information processing apparatus according to the check result in said check step.

9. A non-transitory computer-readable storage medium storing a control program causing a computer to execute a job transmission path control method, which is used in a job processing system having a job processing apparatus, a server that stores a job, and the computer that is connected to the job processing apparatus and is connected to the server by a first connection configuration, for controlling a transmission path through which a job is transmitted from the server to the job processing apparatus, the job transmission path control method comprising:
a determination step of determining whether a connection configuration between the computer and the job processing apparatus is a second connection configuration that is different from the first connection configuration;
a check step of checking whether the job processing apparatus is connected to the server by the first connection configuration when it is determined that the connection configuration between the computer and the job processing apparatus is the second connection configuration in said determination step; and
an instruction step of instructing the server on either of first transmission that transmits the job to the job processing apparatus and second transmission that transmits the job to the computer according to the check result in said check step.
